(19) United States
(12) Patent Application Publication
(10) Pub. No.: US 2026/0010354 A1
(43) Pub. Date: Jan. 8, 2026

(54) Compiler Transformations for Expression Reuse

(71) Applicant: Advanced Micro Devices, Inc., Santa Clara, CA (US)

(72) Inventors: Haritha Madhav C, Palakkad (IN); Tharun Kumar Dangeti, Hyderabad (IN); Venugopal Raghavan, Bengaluru (IN); Anupama Rajesh Rasale, Bangalore (IN)

(73) Assignee: Advanced Micro Devices, Inc., Santa Clara, CA (US)

(21) Appl. No.: 18/765,284

(22) Filed: Jul. 7, 2024

(51) Int. Cl. G06F 8/41; G06F 8/36

(52) U.S. Cl. CPC G06F 8/443; G06F 8/36

(57) ABSTRACT

Compiler transformations for expression reuse are described. In accordance with the described techniques, a system includes a processor and a compiler executing on the processor. The compiler causes the processor to generate an intermediate representation of a program instruction, transform the intermediate expression, and generate executable code of the program instruction from the transformed intermediate representation. As a part of the transforming, the compiler causes the processor to generate equivalent expressions of a program expression of the intermediate representation, select a lowest cost expression of the equivalent expressions and the program expression based on a set of reusable expressions, and replace the program expression with the lowest cost expression.

### BACKGROUND

A compiler is a specialized software program that translates high-level source code into low-level executable code. As a part of this process, the compiler translates the high-level source code into an intermediate representation, which captures the computational meaning of the high-level source code while having a simpler and more uniform structure. The complier performs optimizations on the intermediate representation before translating the optimized intermediate representation to the low-level executable code. Typically, a compiler optimization is called a pass, and many such passes run in a sequence to yield an optimized intermediate representation. Optimizing the intermediate representation results in low-level executable code that is more efficient to execute, e.g., by a processor.

### BRIEF DESCRIPTION OF THE DRAWINGS

FIG. 1 is a block diagram of a non-limiting example system to implement compiler transformations for expression reuse.

FIG. 2 is a block diagram of a non-limiting example implementation of the arithmetic transforms for expression reuse pass of the compiler of FIG. 1 in greater detail.

FIG. 3 is a block diagram of a non-limiting example implementation of the expression generator of the compiler of FIG. 1 in greater detail.

FIG. 4 depicts a non-limiting example illustrating compiler transformations for expression reuse.

FIG. 5 is a flow diagram depicting an algorithm as a step-by-step procedure in an example of implementing compiler transformations for expression reuse.

FIG. 6 is a flow diagram depicting an algorithm as a step-by-step procedure in an example of identifying a lowest cost expression as a part of implementing compiler transformations for expression reuse.

### DETAILED DESCRIPTION

### Overview

Conventional compiler-based optimizations include techniques for common sub-expression elimination, which remove trivial redundancies. This includes, for instance, identifying expressions and sub-expressions that are present in intermediate representations at multiple program points. By way of example, an expression or sub-expression whose value is available because it has already been computed at an earlier program point is replaced by the value rather than performing a redundant computation. Removing trivial redundances in this way results in more efficient program execution. Non-trivial redundancies, however, are more difficult to identify and remove. Non-trivial redundancies refer to those where the expression or sub-expression does not match an already computed expression. In some instances, transforming the expression into a different, equivalent form results in the expression or sub-expression matching the already computed expression.

However, transforming the expression into its different equivalent forms (e.g., equivalent expressions) to identify portions that are replaceable by already computed expressions is a compile time-intensive task. For instance, the number of equivalent expressions increases exponentially as the number of variables and mathematical operations in the expression increases, particularly due to properties such as commutativity, associativity, and distributivity. Searching such a large set of equivalent expressions for reusable expressions results in the increased compile time outweighing the execution benefits of removing the non-trivial redundancies.

To overcome these problems, compiler transformations for expression reuse are described. In accordance with the described techniques, a compiler includes an arithmetic transforms for expression reuse pass that transforms a program expression of an intermediate representation into equivalent expressions using rewrite rules. In at least one implementation, the rewrite rules regulate the number of equivalent expressions generated for a given program expression as well as a complexity of the equivalent expressions. By way of example, the rewrite rules specify which algebraic identities are used in generating the equivalent expressions from the program expression. This enables the compile time and complexity of the non-trivial sub-expression elimination task to be controlled, resulting in an overall performance increase of a device executing an application compiled with the compiler which includes this optimization pass.

In at least one implementation, once the equivalent expressions are generated, e.g., by an expression generator functionality of the compiler, an expression selector functionality of the compiler identifies which sub-expressions of the program expression and its equivalent expressions are able to be realized using reusable expressions. The reusable expressions include a set of available expressions and a set of will-be-available expressions. The set of available expressions includes those that are already computed and whose values are available at a program point of the program expression. The set of will-be-available expressions includes those that are computed after the program point of the program expression and that are dominated by the program point. By way of example, will-be-available expressions that are able to be moved to a program point before the program point of the program expression become part of the set of available expressions.

The expression selector calculates respective costs of the program expression and the equivalent expressions while considering which sub-expressions are present in the reusable expressions and are thus able to be replaced with a corresponding value. Replacing a sub-expression with the corresponding value, for instance, reduces the cost of a given expression. The expression selector compares the respective costs to identify which of the program expressions and the equivalent expressions has a lowest cost, and the lowest cost expression is selected for use in an optimized version of the intermediate representation. When the lowest cost expression includes a movable expression from the set of will-be-available expressions, the movable expression is moved to before the program point of the program expression, thus making the movable expression part of the set of available expressions. By removing the non-trivial redundancies in this way, machine code generated from the optimized intermediate representation is more efficiently executed while constraining the compile time and compile task complexity.

In some aspects, the techniques described herein relate to a system, including a processor, and a compiler executing on the processor and causing the processor to perform operations including generating an intermediate representation of a program instruction, transforming the intermediate representation by generating equivalent expressions of a program expression of the intermediate representation, selecting a lowest cost expression of the equivalent expressions and the program expression based on a set of reusable expressions, and replacing the program expression with the lowest cost expression, and generating executable code of the program instruction from the transformed intermediate representation.

In some aspects, the techniques described herein relate to a system, wherein generating the equivalent expressions of the program expression is based on rewrite rules.

In some aspects, the techniques described herein relate to a system, wherein the rewrite rules define commutativity, associativity, and distributivity properties used in generating the equivalent expressions of the program expression.

In some aspects, the techniques described herein relate to a system, wherein the rewrite rules constrain a number of the equivalent expressions generated during the generating.

In some aspects, the techniques described herein relate to a system, wherein selecting the lowest cost expression of the equivalent expressions and the program expression based on the set of reusable expressions includes identifying sub-expressions of the equivalent expressions and the program expression that are present in the set of reusable expressions, calculating respective costs of the equivalent expressions and the program expression based on reusing corresponding expressions of the set of reusable expressions for the identified sub-expressions, and selecting the lowest cost expression of the equivalent expressions and the program expression based on the respective costs.

In some aspects, the techniques described herein relate to a system, the program instruction is part of a source code of a software program.

In some aspects, the techniques described herein relate to a system, wherein the set of reusable expressions include a set of available expressions and a set of will-be-available expressions.

In some aspects, the techniques described herein relate to a system, wherein the set of available expressions include expressions computed prior to a program point of the program expression, and wherein the set of will-be-available expressions include expressions computed after the program point of the program expression.

In some aspects, the techniques described herein relate to a system, wherein the operations further include in response to the lowest cost expression including a sub-expression within the set of will-be-available expressions, moving a corresponding expression of the set of will-be-available expressions to a current program point.

In some aspects, the techniques described herein relate to a method including compiling a portion of source code of a software program, and during the compiling, transforming an intermediate representation of the portion of the source code by generating equivalent expressions of a program expression of the intermediate representation, selecting a lowest cost expression of the equivalent expressions and the program expression based on a set of reusable expressions, and replacing the program expression with the lowest cost expression.

In some aspects, the techniques described herein relate to a method, wherein generating the equivalent expressions of the program expression is based on rewrite rules that define commutativity, associativity, and distributivity properties used in the generating.

In some aspects, the techniques described herein relate to a method, wherein the rewrite rules further constrain a number of the equivalent expressions generated via the generating.

In some aspects, the techniques described herein relate to a method, wherein selecting the lowest cost expression of the equivalent expressions and the program expression based on the set of reusable expressions includes, identifying sub-expressions of the equivalent expressions and the program expression that are present in the set of reusable expressions, calculating respective costs of the equivalent expressions and the program expression based on reusing corresponding expressions of the set of reusable expressions for the identified sub-expressions, and selecting the lowest cost expression of the equivalent expressions and the program expression based on the respective costs.

In some aspects, the techniques described herein relate to a method, wherein the portion of the source code corresponds to a first program point, and wherein the set of reusable expressions includes an available expression sub-set corresponding to program points before the first program point, and a will-be-available expression sub-set corresponding to program points after the first program point.

In some aspects, the techniques described herein relate to a method, wherein calculating the respective costs of the equivalent expressions and the program expression based on reusing the corresponding expressions of the set of reusable expressions for the identified sub-expressions includes determining if a will-be-available expression of the will-be-available expression sub-set is movable to a program point before the first program point, including the will-be-available expression in calculating the respective costs of the equivalent expressions and the program expression in response to the will-be-available expression being movable to the program point before the first program point, and not including the will-be-available expression in calculating the respective costs of the equivalent expressions that the program expression in response to the will-be-available expression not being movable to the program point before the first program point.

In some aspects, the techniques described herein relate to a method, further including moving a will-be-available expression of the will-be-available expression sub-set to a program point before the first program point in response to the lowest cost expression including the will-be-available expression as a sub-expression.

In some aspects, the techniques described herein relate to a system, including a processor, and a compiler executing on the processor and causing the processor to perform operations including compiling a program instruction of a software program, and during the compiling, transforming an intermediate representation of the program instruction by generating equivalent expressions of a program expression of the intermediate representation, identifying sub-expressions of the equivalent expressions and the program expression that are present in a set of reusable expressions, calculating respective execution costs of the equivalent expressions and the program expression based on substituting the identified sub-expressions with values computed via corresponding expressions of the set of reusable expressions, selecting a lowest cost expression of the equivalent expressions and the program expression based on the respective execution costs, and replacing the program expression with the lowest cost expression.

In some aspects, the techniques described herein relate to a system, wherein the program instruction corresponds to a first program point, and wherein the set of reusable expressions includes an available expression sub-set corresponding to program points before the first program point, and a will-be-available expression sub-set corresponding to program points after the first program point.

In some aspects, the techniques described herein relate to a system, wherein the operations further include excluding a will-be-available expression of the will-be-available expression sub-set from the calculating in response to the will-be-available expression not being movable to a program point before the first program point.

In some aspects, the techniques described herein relate to a system, wherein generating the equivalent expressions is constrained by rewrite rules defining commutativity, associativity, and distributivity properties used in the generating and a number of the equivalent expressions generated.

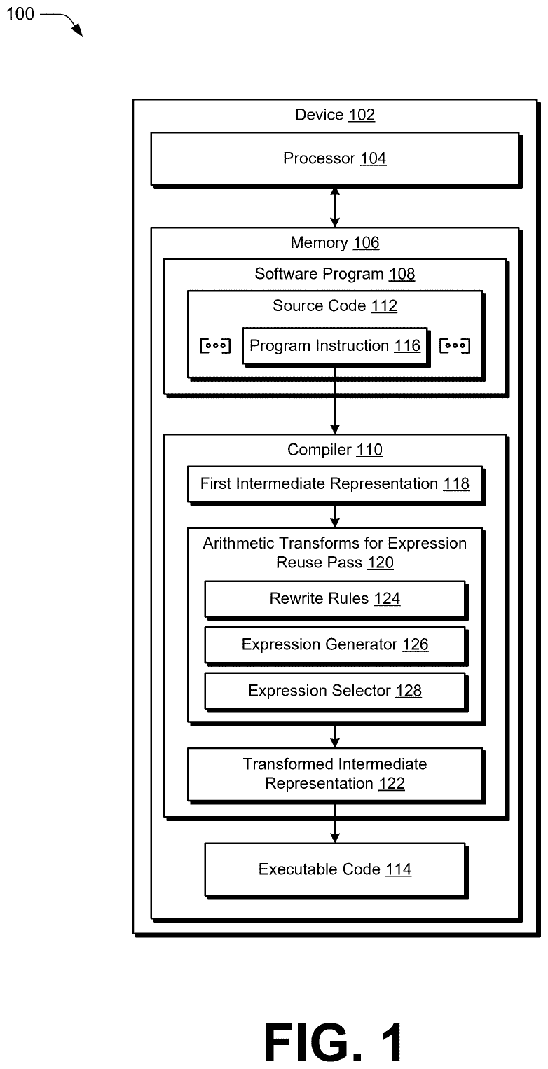

FIG. 1 is a block diagram of a non-limiting example system 100 to implement compiler transformations for expression reuse. The system 100 includes a device 102 having a processor 104 executing thereon based on instructions stored in a memory 106. Examples of the device 102 include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems. In accordance with the described techniques, the processor 104 and the memory 106 are coupled to one another via one or more wired or wireless connections. Example wired connections include, but are not limited to, buses (e.g., a data bus), interconnects, traces, and planes.

The processor 104 is an electronic circuit that performs various operations on and/or using data in the memory 106. Examples of the processor 104 include, but are not limited to, a central processing unit (CPU), a graphics processing unit (GPU), an accelerated processing units (APU), a field programmable gate array (FPGA), a digital signal processor (DSP), a neural processing unit (NPU), a processing-in-memory (PIM) component having an in-memory processor, an application specific integrated circuit (ASIC), another type of integrated circuit (IC), and so forth. For example, the processor 104 reads and executes requests and/or instructions (e.g., of a software program 108 stored in the memory 106), examples of which include to add data, to move data, and to branch. Examples of the software program 108 running on the processor 104 include operating systems and software applications. The processor 104 includes one or more processing units (e.g., cores) to execute the instructions.

The memory 106 is a device or system that is used to store information, such as for use by the processor 104. In one or more implementations, the memory 106 corresponds to semiconductor memory where data is stored within memory cells on one or more integrated circuits. In at least one example, the memory 106 corresponds to or includes volatile memory, examples of which include random-access memory (RAM), dynamic random-access memory (DRAM), synchronous dynamic random-access memory (SDRAM), and static random-access memory (SRAM). Alternatively, or in addition, the memory 106 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). Thus, the memory 106 is configurable in a variety of ways that support compiler transformations for expression reuse without departing from the spirit or scope of the described techniques.

The memory 106 further includes a compiler 110. In one or more implementations, the compiler 110 represents software that runs on the processor 104 to translate (e.g., compile) source code 112 of the software program 108 from a high-level source programming language into machine code, byte code, or some other low-level programming language that is executable by hardware components of the system 100, represented in FIG. 1 as executable code 114. By way of example, the executable code 114 is processed by the processor 104 to run the software program 108. It is to be appreciated that although operations are described herein as being performed by the compiler 110, these operations are performed by the processor 104 in executing the compiler 110. By way of example, the compiler 110 causes the processor 104 to perform specific operations.

The source code 112 includes a program instruction 116. The program instruction 116 is a particular task or subtask of the software program 108 that is written in the high-level source programming language of the source code 112. By way of example, the program instruction 116 is a portion of the source code 112. Broadly, the compiler 110 receives the program instruction 116 and translates the program instruction 116 into an intermediate representation 118 (e.g., a lower-level abstraction of the source code that is platform independent). In at least one implementation, the intermediate representation 118 includes at least one arithmetic and/or logical operator and represents an expression (e.g., a mathematical expression). However, in various scenarios, the intermediate representation 118 is not in a form that will provide the most computationally efficient version (e.g., the version using the fewest computing cycles) of the executable code 114.

Thus, in accordance with the techniques described herein, the compiler 110 includes an arithmetic transforms for expression reuse pass 120. In one or more implementations, the arithmetic transforms for expression reuse pass 120 is an algorithm that is executed (e.g., by the processor 104 executing the compiler 110) to generate a transformed intermediate representation 122 from the intermediate representation 118. The transformed intermediate representation 122, for instance, is a lower cost (e.g., optimized) version of the intermediate representation 118 with respect to computational complexity, computing resource consumption, and/or execution time. Moreover, the transformed intermediate representation 122 produces the same observable output (e.g., the particular task or subtask that is performed by executing the corresponding executable code 114) as the intermediate representation 118. By way of example, the executable code 114 generated from the transformed intermediate representation 122 is more computationally efficient than that generated directly from the intermediate representation 118.

To generate the transformed intermediate representation 122 from the intermediate representation 118, in at least one implementation, the arithmetic transforms for expression reuse pass 120 includes rewrite rules 124, an expression generator 126, and an expression selector 128. By way of example, the rewrite rules 124 define instructions for rewriting the intermediate representation 118 as one or more different equivalent forms using properties such as commutativity, associativity, and distributivity. By way of example, the rewrite rules 124 constrain a number and/or complexity of the one or more different equivalent forms generated for the intermediate representation 118 via the expression generator 126. As a non-limiting example, the number in a range between twenty-five and fifty different equivalent forms (e.g., thirty different equivalent forms). Additionally, or alternatively, the number is a user-tunable value.

In at least one implementation, the rewrite rules 124 are configured to balance a compile time of executing the arithmetic transforms for expression reuse pass 120 with a compute time of executing a less efficient and/or performant version of the executable code 114. Increasing the number and/or complexity of the different equivalent forms produced by the expression generator 126 increases the compile time, for instance. Conversely, decreasing the number and/or complexity of the different equivalent forms produces by the expression generator 126 provides fewer optimization options.

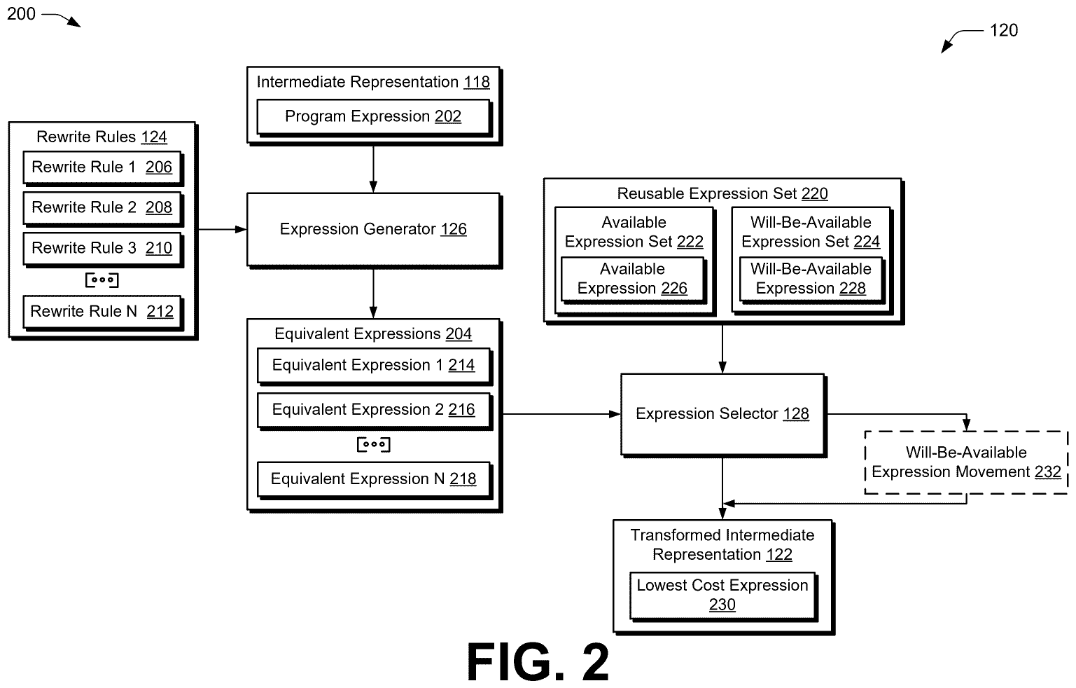

The expression selector 128 is representative of a set of instructions (e.g., a subroutine of the arithmetic transforms for expression reuse pass 120) to find a cost-efficient form of the intermediate representation 118, and the cost-efficient form is used in the transformed intermediate representation 122. By way of example, the expression selector 128 searches the original expression of the intermediate representation 118 and the expressions produced by the expression generator 126 for the lowest cost version, and the lowest cost version is used in the transformed intermediate representation 122. In at least one implementation, the expression selector 128 is configured to reuse available expressions that will be computed by a given program point of the intermediate representation 118. The expression selector 128, for instance, selects the version of the expression that includes equivalent sub-expressions that are available to be reused in order to reduce redundant computations. Additional details of the arithmetic transforms for expression reuse pass 120 will be described herein, e.g., with reference to FIG. 2.

It is to be appreciated that in at least one implementation, it is possible for the transformed intermediate representation 122 to be further optimized, but the transformation is not cost-effective. By way of example, transforming an expression into its different forms is a compile time-intensive task, as the number of mathematical operations in the expression and the properties of the operators in the expression (e.g., commutativity, associativity, and distributivity) increase exponentially. Searching for available expressions to reuse in such a large set reduces performance by increasing the compile time and the processing resources used for the compile task. Thus, the constraints provided by the rewrite rules 124 increase the efficiency of the arithmetic transforms for expression reuse pass 120 and thus the efficiency of the device 102 overall.

As mentioned above, the executable code 114 is generated by the compiler 110 from the transformed intermediate representation 122. By using the arithmetic transforms for expression reuse pass 120 to identify opportunities to reuse available expressions in equivalent forms of the intermediate representation 118, non-trivial redundancies are removed in the resulting executable code 114. By generating the executable code 114 from the transformed intermediate representation 122, performance of the software program 108 is increased without changing the overall result of the program instruction 116.

FIG. 2 is a block diagram of a non-limiting example implementation 200 of the arithmetic transforms for expression reuse pass 120 of the compiler 110 of FIG. 1 in greater detail. The implementation 200 depicts the intermediate representation 118 as including a program expression 202. The program expression 202 corresponds to a first program point. A program point refers to a specific location in a program's code (e.g., the source code 112 of the software program 108 of FIG. 1) during its execution. By way of example, if the first program point dominates a second program point, it is implied that paths from the entry point of the program pass through the first program point to get to the second program point (e.g., the first program point is executed before the second program point).

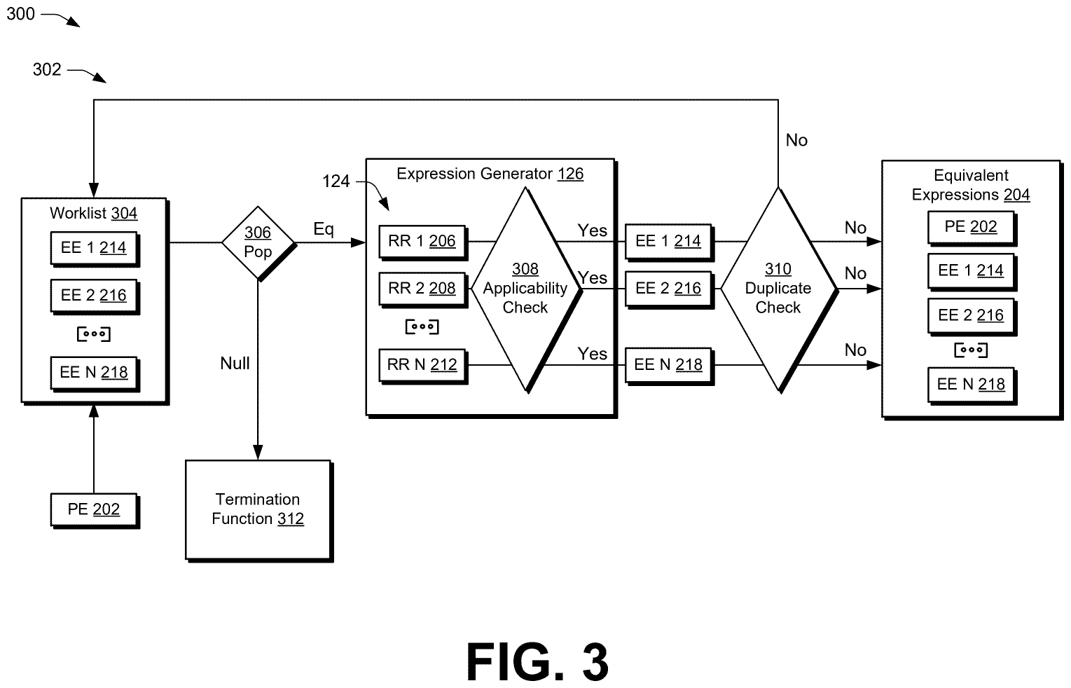

The expression generator 126 receives the program expression 202 and references the rewrite rules 124 to generate equivalent expressions 204 for the program expression 202. The rewrite rules 124 are depicted as including a first rewrite rule 206 (e.g., “rewrite rule 1”), a second rewrite rule 208 (e.g., “rewrite rule 2), a third rewrite rule 210 (e.g., “rewrite rule 3), and an Nth rewrite rule 212 (e.g., “rewrite rule N”). Ellipses denote that additional rewrite rules exist between the third rewrite rule 210 and the N^{th} rewrite rule 212. In at least one variation, however, there are fewer than four rewrite rules in the rewrite rules 124. As non-limiting, illustrative examples, the first rewrite rule 206 describes replacing an expression with a variable (e.g., using a load function, a call function, an allocation function, and so forth), the second rewrite rule 208 describes changing an order of the operands using commutativity (e.g., a+b→b+a), the third rewrite rule 210 describes regrouping the operands using associativity (e.g., a+(b+c)→(a+b)+c and/or (a+b)+c→a+(b+c)), and the and the N^{th} rewrite rule 212 describes regrouping the operands using the distributive property (e.g., a*(b+c)→(a+b)+(a*c) and/or (a+b)*c→(a*c)+(b*c). An example implementation of the expression generator 126 is further described below with reference to FIG. 3.

The equivalent expressions 204 are depicted as including a first equivalent expression 214 (e.g., “equivalent expression 1”), a second equivalent expression 216 (e.g., “equivalent expression 2), and an N^{th} equivalent expression 218 (e.g., “equivalent expression N”). Ellipses denote that additional equivalent expressions exist between the second equivalent expression 216 and the N^{th} equivalent expression 218. Although three equivalent expressions 204 are depicted, in at least one variation, there are fewer than three equivalent expressions 204, e.g., based on a complexity of the program expression 202. Moreover, as mentioned above with respect to FIG. 1, the rewrite rules 124 constrain the number of equivalent expressions 204 generated by the expression generator 126.

The expression selector 128 receives the equivalent expressions 204 and additionally receives a reusable expression set 220. In at least one implementation, the expression selector 128 identifies sub-expressions of the program expression 202 and/or the equivalent expressions 204 that are present in the reusable expression set 220. The reusable expression set 220, for instance, includes two sub-sets of expressions: an available expression set 222 and a will-be-available expression set 224. The available expression set 222 includes at least one available expression 226 that is computed before the first program point (e.g., corresponding to a program instruction that corresponds to a program point before the program instruction 116 of FIG. 1). As such, a resulting value of the available expression 226 is available at the first program point. The will-be-available expression set 224 includes at least one will-be-available expression 228 that will be computed at a future point in the program's execution (e.g., after the first program point) that is dominated by the first program point. As such, a resulting value of the will-be-available expression 228 is not available at the first program point unless the will-be-available expression 228 is moved.

In at least one implementation, the expression selector 128 determines which sub-expressions of the program expression 202 and the equivalent expressions 204 are able to be realized using the reusable expression set 220 (e.g., results of the reusable expression set 220 upon execution) and calculates respective costs of the program expression 202 and the equivalent expressions 204 based thereon. The cost is a measure of the computational resources (e.g., execution time, memory usage, and/or power consumption) used to evaluate the corresponding expression. Having at least one sub-expression in the reusable expression set 220 reduces the cost of a given expression compared to when none of the sub-expressions are present in the reusable expression set 220. For example, the at least one sub-expression is rewritten using the resulting value rather than re-computing the sub-expression at the first program point, thus removing a computational redundancy.

In one or more implementations, to determine the cost of a given expression, the expression selector 128 sums costs of the sub-expression(s) and/or operator(s) of the given expression, taking into account which sub-expressions are present in the reusable expression set 220, if any, and are thus able to be substituted by a value. In instances where the will-be-available expression 228 is identified for reuse in the given expression, the expression selector 128 determines if the will-be-available expression 228 is able to be moved to a program point before the first program point. By way of example, the will-be-available expression 228 is able to be moved to the program point before the first program point if doing so does not change the behavior of the program execution. If the will-be-available expression 228 is not able to be moved, its reuse is not factored into the cost calculation, as the result of the expression will not be computed prior to the first program point. For instance, the expression selector 128 will exclude the will-be-available expression 228, as well as other expressions of the will-be-available expression set 224 that are not movable, from the cost calculation if the result of the will-be-available expression 228 cannot be made available for reuse prior to the first program point. By excluding the will-be-available expression 228 in response to the will-be-available expression 228 not being movable, the expression selector 128 will not consider the gain of reusing the will-be-available expression 228 at the first program point.

The expression selector 128 selects a lowest cost expression 230. By way of example, the expression selector 128 compares the cost of the program expression 202 and the respective costs of the equivalent expressions 204 to select the lowest cost expression 230 therefrom. When the lowest cost expression 230 includes the (movable) will-be-available expression 228, the will-be-available expression 228 is moved to the program point before the first program point. This is represented in FIG. 2 as a will-be-available expression movement 232. The will-be-available expression movement 232 allows the lowest cost expression 230 to utilize the result of the will-be-available expression 228.

The expression selector 128 replaces the program expression 202 with the lowest cost expression 230 to generate the transformed intermediate representation 122. It is to be appreciated, however, that in at least one variation, the program expression 202 is determined to be the lowest cost expression 230. The transformed intermediate representation 122 is an optimized version of the intermediate representation 118 according to the arithmetic transforms for expression reuse pass 120.

As an illustrative, non-limiting example scenario of the above-described techniques, consider the following expressions:

$$val = \frac{( a + b + c ) * d}{( e + f ) / g}$$

$$val 2 = [ ( \frac{b + c}{e + f} ) + \frac{a}{e + f} ] * ( d * g )$$

where val is the program expression 202 and val2 is an equivalent version of val (e.g., the first equivalent expression 214) generated by the expression generator 126 using the rewrite rules 124. If the reusable expression set 220 includes:

$$x = \frac{b + c}{e + f}$$

$$y = \frac{a}{e + f}$$

$$z = d * g$$

then val2 can be rewritten as:

$$val {2}^{′} = [ x + y ] * z$$

using the reusable expression set 220, where x, y, and z are values determined by computing the expressions of the reusable expression set 220 prior to the first program point. In this example, val2′ is a lower cost version of val. That is, the three additions, one multiplication, and two divisions of val are replaced with a single addition and multiplication in val2′. In this example scenario, the lowest cost expression 230 used in the transformed intermediate representation 122 is val2′. The transformed intermediate representation 122 is therefore more computationally efficient than the intermediate representation 118, resulting in an overall performance increase of the software program 108 and of the device 102 overall.

The arithmetic transforms for expression reuse pass 120 iterates through the intermediate representations of the software program 108 instruction-by-instruction. In one or more implementations, an expression is moved from the will-be-available expression set 224 when the corresponding intermediate representation is being processed. After processing, the expression is added to the available expression set 222. In the non-limiting example implementation 200 shown in FIG. 2, for instance, the program expression 202 is removed from the will-be-available expression set 224 while the intermediate representation 118 is processed by the arithmetic transforms for expression reuse pass 120, and the lowest cost expression 230 is added to the available expression set 222 after processing.

FIG. 3 is a block diagram of a non-limiting example implementation 300 of the expression generator 126 of the compiler 110 of FIG. 1 in greater detail. The non-limiting example implementation 300 further includes, from FIG. 2, the program expression 202, the first rewrite rule 206, the second rewrite rule 208, the N^{th} rewrite rule 212, the first equivalent expression 214, the second equivalent expression 216, and the N^{th} equivalent expression 218.

The non-limiting example implementation 300 includes a processing loop 302 for processing a worklist 304 by the expression generator 126 in generating the equivalent expressions 204 for the program expression 202. Initially, the program expression 202 (abbreviated as “PE” in FIG. 3) is added to the worklist 304. The worklist 304 includes a list of expressions that are pending processing by the expression generator 126. In at least one implementation, the worklist 304 includes the program expression 202 and no other expressions upon initialization. A pop operation 306 is performed, which retrieves the next expression from the worklist 304 for processing by the expression generator 126 according to their order in the worklist 304, for instance. In the present example, the pop operation 306 retrieves the program expression 202 during an initial iteration of the processing loop 302, which becomes a current expression (e.g., “Eq” in FIG. 3).

The expression generator 126 receives the current expression and applies the rewrite rules 124, a portion of which are shown in FIG. 3, to generate the equivalent expressions 204. In at least one implementation, the expression generator 126 performs an applicability check 308 to determine if a respective rule of the rewrite rules 124 is applicable to processing the current expression. For instance, the respective rule of the rewrite rules 124 is not applicable when the associated mathematical transformation cannot be performed on the current expression. If applicable, (e.g., “yes”), the respective rule is used by the expression generator 126 to generate the equivalent expressions 204. By way of example, the expression generator 126 generates the first equivalent expression 214 (abbreviated as “EE 1” in FIG. 3) from the program expression 202 using the first rewrite rule 206 (abbreviated as “RR 1” in FIG. 3), the second equivalent expression 216 (abbreviated as “EE 2” in FIG. 3) from the program expression 202 using the second rewrite rule 208 (abbreviated as “RR 2” in FIG. 3), and the N^{th} equivalent expression 218 (abbreviated as “EE N” in FIG. 3) from the program expression 202 using the N^{th} rewrite rule 212 (abbreviated as “RR N” in FIG. 3).

In the non-limiting example implementation 300, a duplicate check 310 is performed to determine if a newly generated equivalent expression is already in the equivalent expressions 204. If the newly generated equivalent expression is not already in the equivalent expressions 204 (e.g., “no”), the newly generated equivalent expression is added to the equivalent expressions 204 and also added to the worklist 304 for further processing by the expression generator 126 during a subsequent iteration of the processing loop 302. For example, in the initial iteration of the processing loop 302, the first equivalent expression 214, the second equivalent expression 216, and the N^{th} equivalent expression 218 are added to the equivalent expressions 204. In at least one implementation, the program expression 202 is also added to the equivalent expressions 204. Moreover, the first equivalent expression 214, the second equivalent expression 216, and the N^{th} equivalent expression 218 are added to the worklist 304.

Upon processing the program expression 202, the pop operation 306 retrieves the next expression from the worklist 304, e.g., the first equivalent expression 214, which becomes the current expression (e.g., “Eq”) processed by the expression generator 126. As such, in at least one implementation, the first equivalent expression 214 (and/or other equivalent expressions in the worklist 304) is further rewritten by expression generator 126 based on the rewrite rules 124, as applicable according to the applicability check 308. This process results in additional equivalent expressions being generated for the program expression 202 indirectly. In an example scenario, the equivalent expressions generated from the first equivalent expression 214 include a duplicate expression, such as the second equivalent expression 216. Accordingly, the second equivalent expression 216 generated from the first equivalent expression 214 is not added to the equivalent expressions 204 and the worklist 304 because it is already present and does not pass the duplicate check 310. Performing the duplicate check 310 avoids redundant processing of the equivalent expressions 204, for instance.

The processing loop 302 continues until the worklist 304 is empty, at which point the pop operation 306 returns a “null” value and a termination function 312 is performed. The termination function 312 exits the processing loop 302 and provides the equivalent expressions 204 to the expression selector 128, such as shown in FIG. 2. The equivalent expressions 204 include the current set of equivalent expressions generated via the processing loop 302, including those indirectly generated from equivalent expressions of the program expression 202.

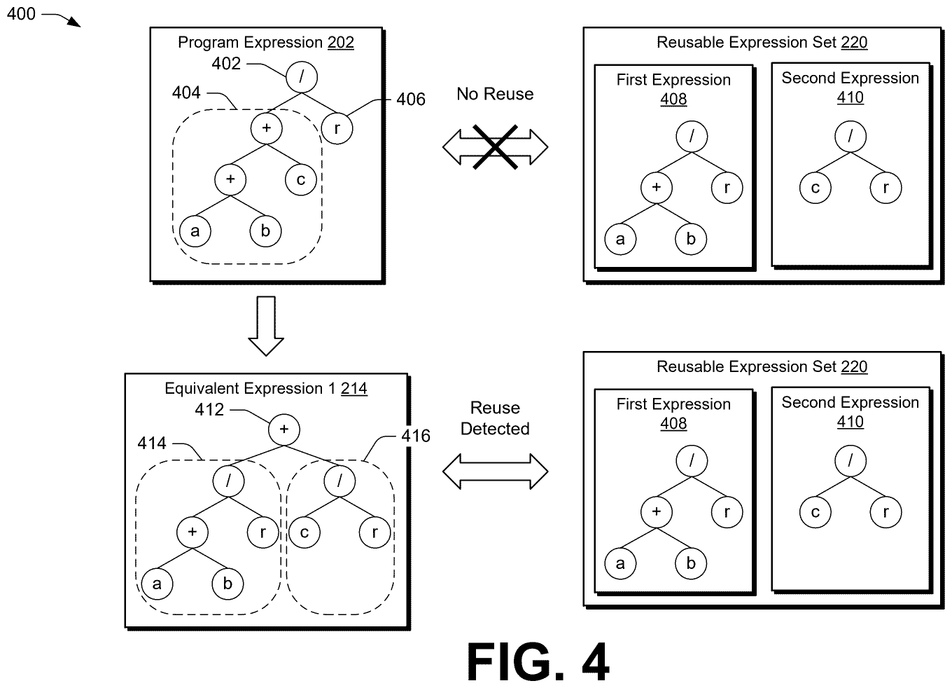

FIG. 4 depicts a non-limiting example 400 illustrating compiler transformations for expression reuse. The non-limiting example 400 includes, from FIG. 2, the program expression 202, the reusable expression set 220, and the first equivalent expression 214. The expressions are depicted as abstract syntax trees, which is one example of an intermediate representation.

In the non-limiting example 400, the program expression 202 includes a root node 402 and two branches, including a left sub-tree 404 and a right sub-tree 406. The left sub-tree 404 and the right sub-tree 406 are sub-expressions. The program expression 202 is:

$$( a + b + c ) / r$$

where the root node 402 is the division operator, the left sub-tree 404 is (a+b+c), and the right sub-tree 406 is r.

In the non-limiting example 400, the reusable expression set 220 includes a first expression 408 and a second expression 410. The first expression 408 is (a+b)/r, and the second expression 410 is c/r. Neither the left sub-tree 404 nor the right sub-tree 406 is able to be rewritten with the first expression 408 or the second expression 410. As such, reuse of the reusable expression set 220 is not possible for the program expression 202.

The program expression 202 is rewritten by the expression generator 126 based on the rewrite rules 124, such as described above with respect to FIGS. 1 and 2, resulting in the first equivalent expression 214 (e.g., of the equivalent expressions 204). In the non-limiting example 400, the first equivalent expression includes a root node 412, a left sub-tree 414, and a right sub-tree 416. The first equivalent expression 214 is depicted as:

$$[ ( a + b ) / r ] + ( c / r )$$

where the root node 412 is the addition operator, the left sub-tree 414 is (a+b)/r, and the right sub-tree 416 is c/r. The left sub-tree 414 is the same as the first expression 408, and the right sub-tree 416 is the same as the second expression 410. As such, the first equivalent expression 214 is able to be realized using the reusable expression set 220 (e.g., results of the reusable expression set 220). That is, the left sub-tree 414 is replaced by a first result of the first expression 408 (e.g., x when (a+b)/r=x), and the right sub-tree 416 is replaced by a second result of the second expression 410 (e.g., y when c/r=y), resulting in the expression x+y for the lowest cost expression 230 (not shown in FIG. 4). As such, the two additions and one division of the program expression 202 are replaced by a single addition in the lowest cost expression 230, which is more computationally efficient and thus more cost-effective.

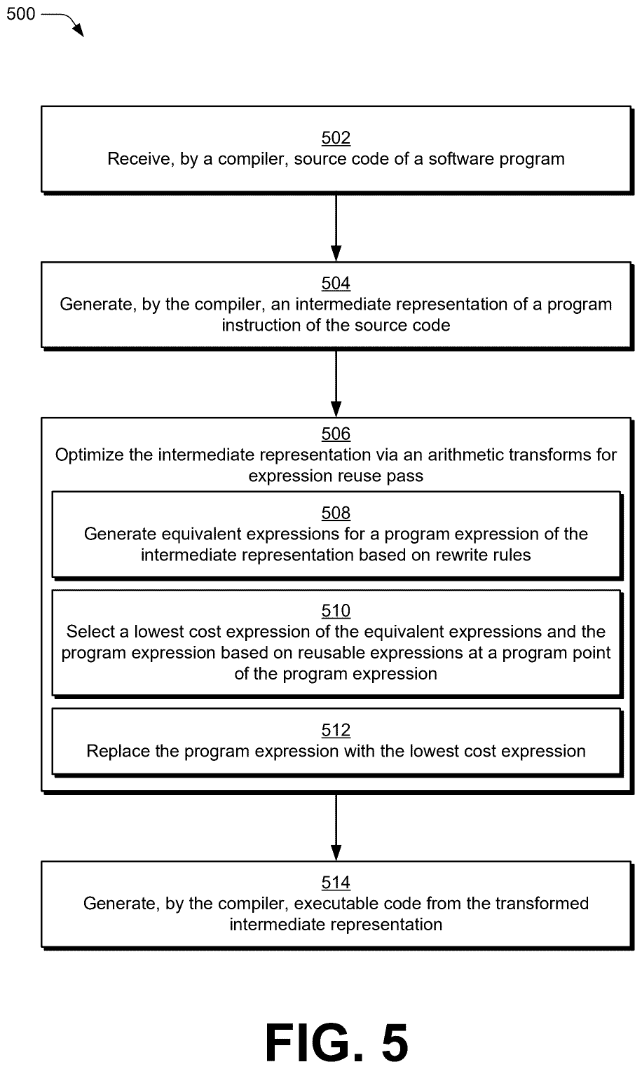

FIG. 5 is a flow diagram depicting an algorithm as a step-by-step procedure 500 in an example of implementing compiler transformations for expression reuse.

Source code of a software program is received by a compiler (block 502). By way of example, the source code 112 includes a plurality of program instructions, such as the program instruction 116, that represent operating tasks or subtasks performed in executing the software program 108, e.g., by the processor 104. The source code 112 is written in various high-level programming languages that are not directly executable by the processor 104.

An intermediate representation of the program instruction of the source code is generated by the compiler (block 504). By way of example, the compiler 110 generates the intermediate representation, such as the intermediate representation 118, from the program instruction 116. The compiler 110 generates intermediate representations of the source code 112 on a per-instruction basis. The intermediate representation 118 captures the computational meaning of the program instruction 116 while having a simpler and more uniform structure.

The intermediate representation is transformed into a lower cost form by the compiler via an arithmetic transforms for expression reuse pass (block 506). By way of example, the lower cost form increases processing efficiency, reduces processing time, and/or reduces energy consumption by removing redundant calculations and/or the number of operators in the computation. Moreover, the arithmetic transforms for expression reuse pass 120 enables non-trivial redundancies to be removed by transforming the intermediate representation 118 into equivalent forms in a compile-efficient manner.

As a part of transforming the intermediate representation into the lower cost form via the arithmetic transforms for expression reuse pass, equivalent expressions are generated for a program expression of the intermediate representation based on rewrite rules (block 508). By way of example, the rewrite rules 124 include instructions for generating the equivalent expressions from the program expression (e.g., the program expression 202 of FIG. 2) using properties such as commutativity, associativity, and distributivity. Moreover, the rewrite rules 124 constrain the computational complexity and/or number of equivalent expressions generated for the program expression in order to regulate a compile time of executing the arithmetic transforms for expression reuse pass 120. In at least one implementation, the expression generator 126 uses the rewrite rules 124 to generate the equivalent expressions 204 using the processing loop 302 of FIG. 3.

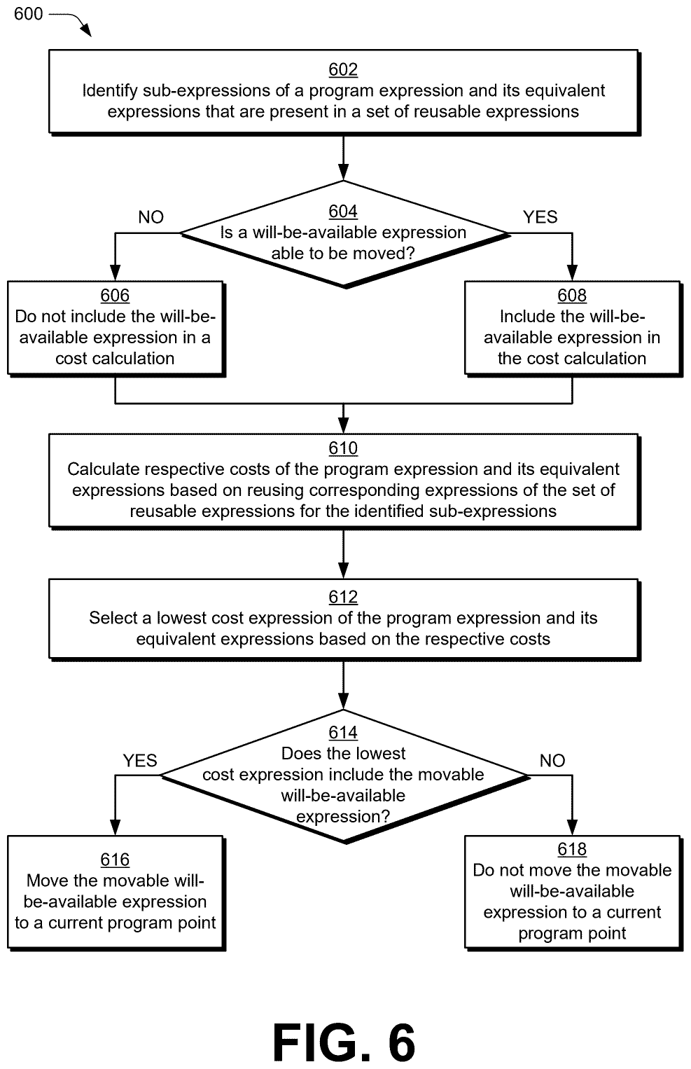

As a part of transforming the intermediate representation into the lower cost form via the arithmetic transforms for expression reuse pass, a lowest cost expression of the equivalent expressions and the program expression is selected based on reusable expressions at a program point of the program expression (block 510). By way of example, the expression selector 128 determines which sub-expressions of the program expression 202 and the equivalent expressions 204, if any, are present in the reusable expressions to find the lowest cost expression 230. An example subroutine performed by the expression selector 128 to find the lowest cost expression using the reusable expressions is further described below with respect to FIG. 6.

As a part of transforming the intermediate representation into the lower cost form via the arithmetic transforms for expression reuse pass, the intermediate representation is transformed into an optimized intermediate expression using the lowest cost expression (block 512). By way of example, the program expression 202 is replaced by the lowest cost expression 230 to generate the optimized intermediate expression (e.g., the transformed intermediate representation 122). It is to be appreciated that in various scenarios, the program expression 202 is the lowest cost expression 230, such as when the program expression 202 is able to be realized using the reusable expressions.

Executable code is generated by the compiler from the optimized intermediate representation (block 514). By way of example, the executable code 114 is executable by the processor 104 to run the software program 108. Moreover, the executable code 114 is optimized machine code generated from the source code 112 on a per-instruction basis.

FIG. 6 is a flow diagram depicting an algorithm as a step-by-step procedure 600 in an example of identifying a lowest cost expression as a part of implementing compiler transformations for expression reuse. In at least one implementation, the procedure 600 is a subroutine of the step-by-step procedure 500 of FIG. 5. By way of example, the procedure 600 is executed at the block 510.

Sub-expressions of a program expression and its equivalent expressions that are present in a set of reusable expressions are identified (block 602). By way of example, the reusable expression set 220 includes the available expression set 222 corresponding to expressions computed before a program point of the program expression 202 (e.g., available expressions) and the will-be-available expression set 224 corresponding to expressions that will be computed after the program point of the program expression 202 (e.g., will-be-available expressions). In at least one implementation, the expression selector 128 searches the reusable expression set 220 for the sub-expressions to identify which sub-expressions, and thus which expressions of the program expression 202 and the equivalent expressions 204, are able to be realized with values that have already been computed by the program point of the program expression 202.

It is determined if a will-be-available expression is able to be moved (block 604). By way of example, the will-be-available expression 228 will not be computed prior to the program point of the program expression 202 if the will-be-available expression 228 cannot be moved. As such, if not able to be moved, the will-be-available expression 228 is not able to be used to realize the corresponding sub-expression. The will-be-available expression 228 is able to be moved when doing so does not change the behavior of the program execution. On the other hand, the will-be-available expression 228 is not able to be moved when doing so changes the overall program behavior.

If the will-be-available expression is not able to be moved, the will-be-available expression is not included in a cost calculation (block 606). By way of example, gains of reusing the will-be-available expression 228 will not be taken into account when the will-be-available expression 228 is not able to be computed prior to the program point of the program expression 202.

In contrast, if the will-be-available expression is able to be moved, the will-be-available expression is included in the cost calculation (block 608). By way of example, when the will-be-available expression 228 is able to be moved, the will-be-available expression 228 is moved to the available expression set 222 prior to the program point of the program expression 202. As such, the will-be-available expression 228 will be computed prior to the program point of the program expression 202 and thus can be used to rewrite the corresponding sub-expression.

Respective costs of the program expression and its equivalent expressions are calculated based on reusing corresponding expressions of the set of reusable expressions for the identified sub-expressions (block 610). By way of example, the expression selector 128 sums costs of the sub-expression(s) and/or operator(s) of a corresponding expression of the program expression 202 or the equivalent expressions 204 to determine the respective costs. Substituting a sub-expression with a value by reusing the corresponding expression of the reusable expression set 220 reduces the cost, for instance. Moreover, reducing the number of operators in the corresponding expression and/or a computational complexity of the corresponding expression reduces the cost. The cost is a measure of the computational resources (e.g., execution time, memory usage, and/or power consumption) used to evaluate the corresponding expression.

A lowest cost expression of the program expression and its equivalent expressions is selected based on the respective costs (block 612). By way of example, the expression selector 128 compares the respective costs of the program expression 202 and the equivalent expressions 204 to select the lowest cost expression 230. The lowest cost expression 230, for instance, has the shortest execution time, memory usage, and/or power consumption of the program expression 202 and the equivalent expressions 204. In at least one implementation, the lowest cost expression 230 is able to be realized using the reusable expression set 220.

It is determined if the lowest cost expression includes the movable will-be-available expression (block 614). By way of example, the lowest cost expression 230 includes the (movable) will-be-available expression 228 when at least a sub-expression of the lowest cost expression 230 matches (e.g., is the same as) the will-be-available expression 228. In contrast, the lowest cost expression 230 does not include the (movable) will-be-available expression 228 when none of the sub-expressions of the lowest cost expression 230 match the (movable) will-be-available expression 228.

In response to the lowest cost expression including the movable will-be-available expression, the movable will-be-available expression is moved to a current program point (block 616). Moving the will-be-available expression 228 to the current program point makes it available for use by the lowest cost expression 230. It is to be appreciated that in various scenarios, the lowest cost expression 230 utilizes more than one movable will-be-available expression of the will-be-available expression set 224. In such instances, all of the movable will-be-available expressions are moved.

In response to the lowest cost expression not including the movable will-be-available expression, the movable will-be-available expression is not moved to the current program point (block 618). By way of example, even though the will-be-available expression 228 is movable, it is not reused by the lowest cost expression 230 at the current program point. As such, there is no benefit to moving the will-be-available expression 228 to be computed before the lowest cost expression 230.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the device 102, the processor 104, the memory 106, the software program 108, and the compiler 110) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), one or more Field Programmable Gate Arrays (FPGAs) circuits, any other type of integrated circuit (IC), and/or a state machine.

In one or more implementations, the methods and procedures provided herein are implemented in a compiler, and the computer program, software, or firmware generated is incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system, comprising:
a processor; and
a compiler executing on the processor and causing the processor to perform operations comprising:
generating an intermediate representation of a program instruction;
transforming the intermediate representation by:
generating equivalent expressions of a program expression of the intermediate representation;
selecting a lowest cost expression of the equivalent expressions and the program expression based on a set of reusable expressions; and
replacing the program expression with the lowest cost expression; and
generating executable code of the program instruction from the transformed intermediate representation.

2. The system of claim 1, wherein generating the equivalent expressions of the program expression is based on rewrite rules.

3. The system of claim 2, wherein the rewrite rules define commutativity, associativity, and distributivity properties used in generating the equivalent expressions of the program expression.

4. The system of claim 2, wherein the rewrite rules constrain a number of the equivalent expressions generated during the generating.

5. The system of claim 1, wherein selecting the lowest cost expression of the equivalent expressions and the program expression based on the set of reusable expressions comprises:
identifying sub-expressions of the equivalent expressions and the program expression that are present in the set of reusable expressions;
calculating respective costs of the equivalent expressions and the program expression based on reusing corresponding expressions of the set of reusable expressions for the identified sub-expressions; and
selecting the lowest cost expression of the equivalent expressions and the program expression based on the respective costs.

6. The system of claim 1, the program instruction is part of a source code of a software program.

7. The system of claim 1, wherein the set of reusable expressions include a set of available expressions and a set of will-be-available expressions.

8. The system of claim 7, wherein the set of available expressions comprise expressions computed prior to a program point of the program expression, and wherein the set of will-be-available expressions comprise expressions computed after the program point of the program expression.

9. The system of claim 7, wherein the operations further comprise:
in response to the lowest cost expression including a sub-expression within the set of will-be-available expressions, moving a corresponding expression of the set of will-be-available expressions to a current program point.

10. A method comprising:
compiling a portion of source code of a software program; and
during the compiling, transforming an intermediate representation of the portion of the source code by:
generating equivalent expressions of a program expression of the intermediate representation;
selecting a lowest cost expression of the equivalent expressions and the program expression based on a set of reusable expressions; and
replacing the program expression with the lowest cost expression.

11. The method of claim 10, wherein generating the equivalent expressions of the program expression is based on rewrite rules that define commutativity, associativity, and distributivity properties used in the generating.

12. The method of claim 11, wherein the rewrite rules further constrain a number of the equivalent expressions generated via the generating.

13. The method of claim 10, wherein selecting the lowest cost expression of the equivalent expressions and the program expression based on the set of reusable expressions comprises:
identifying sub-expressions of the equivalent expressions and the program expression that are present in the set of reusable expressions;
calculating respective costs of the equivalent expressions and the program expression based on reusing corresponding expressions of the set of reusable expressions for the identified sub-expressions; and
selecting the lowest cost expression of the equivalent expressions and the program expression based on the respective costs.

14. The method of claim 13, wherein the portion of the source code corresponds to a first program point, and wherein the set of reusable expressions comprises:
an available expression sub-set corresponding to program points before the first program point; and
a will-be-available expression sub-set corresponding to program points after the first program point.

15. The method of claim 14, wherein calculating the respective costs of the equivalent expressions and the program expression based on reusing the corresponding expressions of the set of reusable expressions for the identified sub-expressions comprises:
determining if a will-be-available expression of the will-be-available expression sub-set is movable to a program point before the first program point;
including the will-be-available expression in calculating the respective costs of the equivalent expressions and the program expression in response to the will-be-available expression being movable to the program point before the first program point; and
not including the will-be-available expression in calculating the respective costs of the equivalent expressions that the program expression in response to the will-be-available expression not being movable to the program point before the first program point.

16. The method of claim 14, further comprising:
moving a will-be-available expression of the will-be-available expression sub-set to a program point before the first program point in response to the lowest cost expression including the will-be-available expression as a sub-expression.

17. A system, comprising:
a processor; and
a compiler executing on the processor and causing the processor to perform operations comprising:
compiling a program instruction of a software program; and
during the compiling, transforming an intermediate representation of the program instruction by:
generating equivalent expressions of a program expression of the intermediate representation;
identifying sub-expressions of the equivalent expressions and the program expression that are present in a set of reusable expressions;
calculating respective execution costs of the equivalent expressions and the program expression based on substituting the identified sub-expressions with values computed via corresponding expressions of the set of reusable expressions;
selecting a lowest cost expression of the equivalent expressions and the program expression based on the respective execution costs; and
replacing the program expression with the lowest cost expression.

18. The system of claim 17, wherein the program instruction corresponds to a first program point, and wherein the set of reusable expressions comprises:
an available expression sub-set corresponding to program points before the first program point; and
a will-be-available expression sub-set corresponding to program points after the first program point.

19. The system of claim 18, wherein the operations further comprise:
excluding a will-be-available expression of the will-be-available expression sub-set from the calculating in response to the will-be-available expression not being movable to a program point before the first program point.

20. The system of claim 17, wherein generating the equivalent expressions is constrained by rewrite rules defining commutativity, associativity, and distributivity properties used in the generating and a number of the equivalent expressions generated.
